(19) United States
(12) Patent Application Publication
(10) Pub. No.: US 2015/0359171 A1
(43) Pub. Date: Dec. 17, 2015

(54) AUXILIARY MULCHING MOWER BLADE

(71) Applicant: Walter BUTLER, Southwest Ranches, FL (US)

(72) Inventor: Walter BUTLER, Southwest Ranches, FL (US)

(21) Appl. No.: 14/741,683

(22) Filed: Jun. 17, 2015

Related U.S. Application Data
(60) Provisional application No. 62/013,042, filed on Jun. 17, 2014.

(51) Int. Cl. A01D 34/73; A01D 34/00

(52) U.S. Cl. CPC A01D 34/73; A01D 34/005

(57) ABSTRACT

An auxiliary mower cutting blade attachable to a mounting member of a lawnmower. The auxiliary mower cutting blade includes a mid-section portion forming a first longitudinal plane, first and second wing portions, each extending in a substantially upward-angled direction from a corresponding side of the mid-section portion, and first and second end portions, each extending from a corresponding wing portion. The first and second end portions form a second longitudinal plane, the second longitudinal plane being above the first longitudinal plane. A cutting region may be disposed on at least one edge of the first end portion and the second end portion, the cutting region including a downward-angled cutting edge.

### CROSS-REFERENCE TO RELATED APPLICATION

This application is related to and claims priority to U.S. Provisional Patent Application Ser. No. 62/013,042, filed Jun. 17, 2014, entitled “AUXILIARY MULCHING MOWER BLADE”, the entirety of which is incorporated herein by reference.

### STATEMENT REGARDING FEDERALLY SPONSORED RESEARCH OR DEVELOPMENT

n/a

### TECHNICAL FIELD

The present disclosure relates to lawn maintenance and more specifically to an auxiliary lawnmower blade for use on lawnmowers in conjunction with a primary blade.

### BACKGROUND

Traditional lawnmower blade configurations have proven to be inadequate when it comes to airflow design and circulating the debris caused by the blades. Many current designs include blades aligned along a single plane line. The result is that the blades do not circulate the debris enough, especially in the center area of the mower's primary blade, or that they create too much airflow causing an inferior cut. This creates debris that is left behind on the grass being cut. The resultant debris eventually becomes thatch that actually impedes future development of the turf, and leaves an unsightly appearance behind. Other single combination lawnmower blades on the market tend to be expensive and are difficult to sharpen, causing them to be discarded quickly, adding to our existing landfill problem.

Thus, what is needed is a new lawnmower blade design that will improve upon the deficiencies of state of the art blades.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed is a design for an auxiliary lawnmower blade that can be used with a primary cutting blade. The auxiliary blade of the present design can be used to cut lawn particles much finer than existing blades, can modify airflow in a superior manner, can thrust debris down towards the bottom of the lawnmower where the debris can be easily expelled, is simple to maintain, can be added or removed independently of the primary blade, and can be reused even after the primary cutting blade has worn out.

In one aspect of the disclosure an auxiliary mower cutting blade attachable to a mounting member of a lawnmower is provided. The auxiliary mower cutting blade includes a mid-section portion forming a first longitudinal plane, a first wing portion extending in a substantially upward-angled direction from a first side of the mid-section portion and a second wing portion extending in a substantially upward-angled direction from a second side of the mid-section portion, and a first end portion extending from the first wing portion and a second end portion extending from the second wing portion, the first and second end portions forming a second longitudinal plane, the second longitudinal plane being above the first longitudinal plane.

In another aspect of the disclosure, an auxiliary mower cutting blade is provided. The auxiliary mower cutting blade includes a mid-section portion forming a first longitudinal plane, a first wing portion extending in a substantially upward-angled direction from a first side of the mid-section portion and a second wing portion extending in a substantially upward-angled direction from a second side of the mid-section portion, and a first end portion extending from the first wing portion and a second end portion extending from the second wing portion, the first and second end portions forming a second longitudinal plane, the second longitudinal plane being above the first longitudinal plane. The auxiliary mower cutting blade also includes a cutting region disposed on an edge of at least one of the first end portion and the second end, the cutting region comprises a downward-sloping cutting edge.

In yet another aspect of the disclosure, a lawnmower blade apparatus attachable to a mounting member of a lawnmower is provided. The apparatus includes a primary cutting blade affixed to the mounting member in a first orientation and an auxiliary cutting blade affixed to the mounting member in a second orientation. The auxiliary cutting blade includes a mid-section portion forming a first longitudinal plane, a first wing portion extending in a substantially upward-angled direction from a first side of the mid-section portion and a second wing portion extending in a substantially upward-angled direction from a second side of the mid-section portion, and a first end portion extending from the first wing portion and a second end portion extending from the second wing portion, the first and second end portions forming a second longitudinal plane, the second longitudinal plane being above the first longitudinal plane.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a front view of the auxiliary mulching mower blade of the present disclosure;

FIG. 2 illustrates a bottom view of the auxiliary mulching mower blade of the present disclosure;

FIG. 3 illustrates a perspective side view of the auxiliary mulching mower blade of the present disclosure;

FIG. 4 illustrates a side view of the agitator plate of the auxiliary mulching mower blade of the present disclosure;

FIG. 5 illustrates a side view of a lawnmower deck including a primary cutting blade and the auxiliary mower blade of the present disclosure;

FIG. 6 illustrates an alternate side view of a lawnmower deck showing a primary cutting blade and the auxiliary mower blade of the present disclosure;

FIG. 7 illustrates a bottom view of a lawn mower deck including multiple primary mower blades and corresponding auxiliary mulching mower blades of the present disclosure; and

FIG. 8 illustrates a bottom view of an alternate lawn mower deck including a single primary mower blade and corresponding auxiliary mulching mower blade of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure relates to one or more auxiliary mower blades for use in lawnmowers. The auxiliary blades can be mounted above or below primary blades, and in can include a central hole such that the auxiliary blades can use the same bolt attachment as originally used for the mower's primary cutting blade.

The auxiliary blades of the present disclosure can be used in all types of lawnmowers including rotary power lawnmowers powered by gas engines or electric motors using blades for cutting and mulching of grass and leaves.

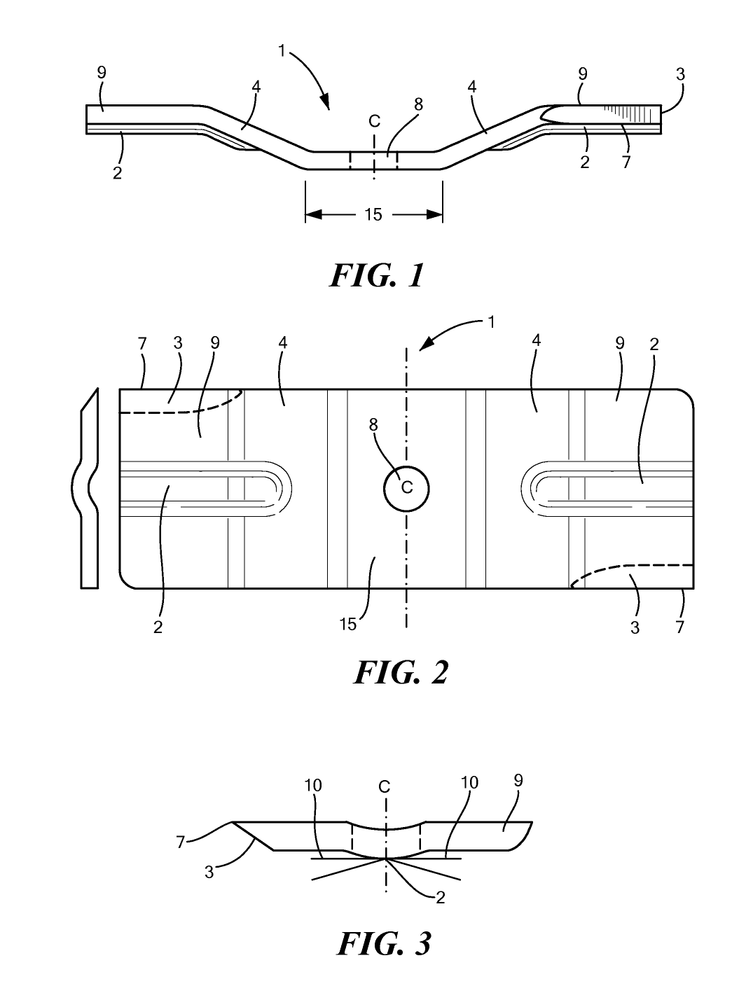

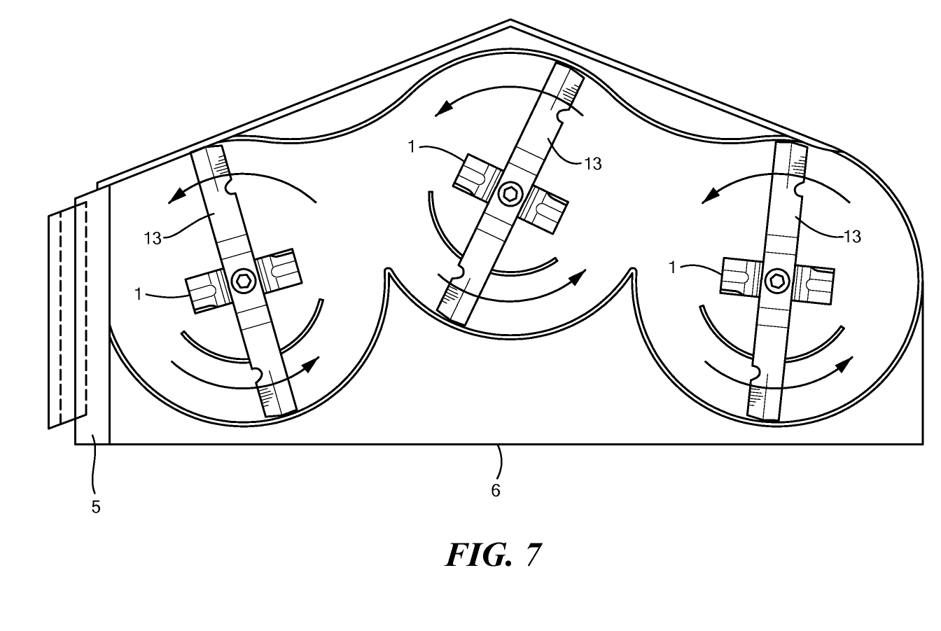

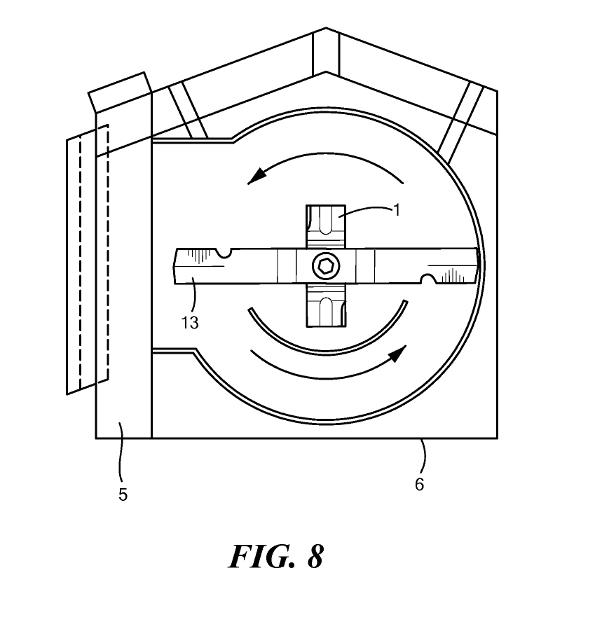

FIG. 1 is a front view of the auxiliary mower blade 1 of the present disclosure. Auxiliary mower blade 1, described in further detail below, includes an inverted gull wing design and can be used in conjunction with a primary cutting blade. As shown in FIGS. 7 and 8 and discussed below, a primary blade may affixed to a mounting member of the lawnmower such as a spindle in a first orientation and auxiliary mower blade 1 may be affixed to the spindle in a second orientation such that when the primary cutting blade is in the first orientation and auxiliary mower cutting blade 1 is in the second orientation, the auxiliary mower blade 1 is offset from the primary cutting blade. The offset can be at any angle. For example, in some instances auxiliary mower blade 1 may be affixed to the mounting member of the lawnmower and set at a second orientation where auxiliary mower blade 1 is offset 10-15% with respect to the position of the primary blade, in its first orientation. In other instances, the placement of auxiliary mower blade 1 may be at substantially 90 degrees relative to the primary cutting blade to allow for independent action upon the airflow in the center portion, upper portion and lower portion of the mower deck. This independent action consists of limiting the amount of partly processed grass that gets left in the center area of the primary blade that is not fully picked up in the rear portion of the mower deck and is therefore left behind as a trail of uncut grass.

Auxiliary mower blade 1 enhances rotation of clippings and debris in the center of the primary blade area. This aids in keeping the grass rotating in an otherwise dead zone. Auxiliary mower blade 1 reduces the size of the clippings by adding additional cutting edges at a different level, above that of the primary blade. Further, the inverted gull wing design serves to raise the cutting edges of auxiliary mower blade 1 even higher and further away from the primary blade. This serves to cut the already-cut clippings and reduces clipping size, thus creating a less conspicuous clipping suitable for faster decomposition, returning nutrients to the soil without creating long term thatch issues. Auxiliary mower blade 1 also eliminates the buildup of grass in the center area of the blade in its dead zone that traditionally causes inefficient air flow throughout the deck. The build-up of grass caused by typical blades causes the deck to become overcrowded or plugged with grass, leaves or other debris. This, in turn, leads to inefficient use of the horsepower created by the engine or motor of the mower. This also leads to slower production, higher fuel requirements, shorter battery life for electric battery operated mowers, as well as greater wear and shorter life of all components, while leaving a less than desirable look on the freshly mowed turf.

The cutting edges, or reverse grind regions of auxiliary mower blade 1 allows for a sharp, clean initial cut of debris and unlike a traditional edge that throws the cut debris upwards, the cutting edge of auxiliary mower blade 1, along with the elongated rib designed in the center of the blade (discussed in greater detail below), propel the cut debris deep into the grass bed, as a very small mulched particle, usually about ⅛ of an inch to ¼ of an inch in size. These smaller particles are left behind and are not picked back up by the mower. These small particles of grass or leaves are not visible on the top surface of the freshly cut grass. This look is very desirable, and up to now could only be achieved by using a grass collection device on the mowers. The independent action described above occurs without disrupting the primary air flow created by the primary cutting blade in the outer circumference of the lower portion of the mower deck.

Auxiliary mower blade 1 reduces the clipping size of the grass or leaves and assists the primary blade with air flow and rotation of debris underneath the upper and lower section of the mower deck. This is especially critical in mulching mower decks. Auxiliary mower blade 1 can also be used on standard discharge mowers in the above capacity, reducing clipping size and assisting in discharging the smaller-sized debris out from under the deck through the discharge opening, thus assisting in the dispersion of grass.

Auxiliary mower blade 1 of the present disclosure also provides an improved power lawn mower which will eliminate the necessity for raking and hauling of debris after mowing. Auxiliary mower blade 1 also helps mowers to improve the condition of the lawn by mulching the mown grass during the mowing operation by making smaller particles of debris clippings, and furthermore driving them deep into the grass rather than leaving them on the surface. This serves to speed up decomposition thus eliminating thatch and accelerating the rate at which the nutrients are returned to the soil. This also assists in eliminating clippings and leaves from being deposited into landfills, leaving them in the turf where they belong to create future topsoil.

Referring to FIG. 1, auxiliary mower blade 1 includes a mid-section portion 15 that may include a center aperture 8, which allows a mounting member such as a bolt or other attachment mechanism to secure auxiliary mower blade 1 to a lawnmower housing or deck. The same bolt can be used to secure the primary blade to the housing. Mid-section portion 15 is substantially horizontal and forms a first longitudinal plane. Auxiliary mower blade 1 also includes first and second wing portions 4 that extend in a substantially upward-angled direction from each side of mid-section portion 15. First and second wing portions 4 form an angle with respect to the first longitudinal plane of mid-section portion 15. In one embodiment, the angle formed by first and second wing portions 4 is 45 degrees with respect to the first longitudinal plane. In other embodiments the angle formed by first and second wing portions 4 is 30 degrees with respect to the first longitudinal plane. A 45 degree angle is sometimes used rather than a lower angle when, for example, a longer cutting edge is desired. This allows for the mid-section portion 15 to be adaptable to work with a variety of different-sized spindles. The present disclosure does not limit the angle either wing portion 4 makes with the first longitudinal plane formed by mid-section portion 15. Further, the angle of the first wing portion 4 with respect to the first longitudinal plane need not be the same as the angle of the second wing portion 4 with respect to the first longitudinal plane.

Auxiliary mower blade 1 also includes first and second end portions 9, each extending substantially horizontally from a corresponding wing portion 4 as shown in FIG. 1. First and second end portions 9 form a secondary plane, which is at a different and higher longitudinal plane than the center section 15 of blade 1. In one embodiment, beneath one or both end portions 9 are rib sections 2. Rib sections 2 can extend along a substantial length of a bottom surface of end portions 9. In one embodiment, rib sections 2 extend the entire length of each end portion 9 and also extend along at least a portion of the bottom surface of one or both wing portions 4. Rib sections 2 are used for strength and airflow direction and create a camber similar to that found in an airplane wing in order to help create airflow in a downward direction. One or both rib sections 2 can be curved to create a rounded surface.

A reverse grind cutting region 3 is located at the end of each end portion 9. Cutting region 3 serves to create a clean, sharp cut, and an initial downward thrust that, in certain embodiments, is then further emphasized by the rib section 2. Although only one cutting region 3 is shown in FIG. 1, it is within the scope of the present disclosure to include more than one cutting region 3, for example, one on the left end portion 9 and one on the right end portion 9. In one embodiment, auxiliary mower blade 1 includes cutting region 3 along the front edge of right end portion 9 and no cutting region 3 along the front edge of left end portion 9, as shown in FIG. 1. However (as best shown in FIG. 2), in another embodiment, there is a cutting region 3 at the front edge of right end portion 9 and another cutting region at the rear edge of left end portion 9.

In other embodiments, cutting regions 3 are included in different arrangements on blade 1, i.e., cutting regions 3 can be disposed on both the front and back edges of both the first end portion and the second end portions 9. Each cutting region 3 can include a cutting edge 7. This can best be seen in FIG. 3. Cutting edge 7 is a downward-sloping, angled cutting edge, where the slope of the edge slopes in a downward-angled direction from the top of the edge of end portion 9 towards the bottom of the edge of end portion 9.

Referring again to FIG, 1, a first longitudinal axis extends through mid-section 15. This longitudinal plane is at a lower elevation than a second longitudinal axis formed by secondary plane end portions 9. Therefore, auxiliary mower blade 1 is configured in an upwardly angled configuration due to upwardly-angled wing portions 4. As discussed above, mid-section 15 may include a circular, central aperture 8 having a variable diameter and being centered on the first blade longitudinal axis for mounting to a mounting member, such as a spindle shaft. The area adjacent to central mounting aperture 8 can have nubs protruding downward relative to the outer edges of the primary blade to restrict movement of blades from, for example, the 90-degree offset initially set during mounting of the blades. This arrangement can be used on large multi-blade commercial mowers as well as homeowner-style, single blade push mowers.

The dimensions of auxiliary mower blade 1 can vary according to need. For example, in one embodiment, auxiliary mower blade 1 is approximately 9 inches in length, 2-3 inches includes in width, and wing portions 4 form a 45 degree angle with respect to the first longitudinal plane of mid-section portion 15. Mid-section portion 15 can be, in one embodiment, 2-3 inches in length, while wing portions 4, can be 1 inch in length. Cutting edges 7 can be any length, and in one embodiment, cutting edges 7 are 1½ inches in length. It is within the scope of the present disclosure to provide an auxiliary mower blade 1 having cutting edges 7 of various angles. In one embodiment, the downward-sloping angle is 30 degrees. Further, it is within the scope of the present disclosure to provide an auxiliary mower blade 1 of varying dimensions, including length and width of auxiliary mower blade 1, length of mid-section portions 15, wing portions 4, and end portions 9, and angle of wind portions 4 with respect to the first longitudinal plane formed by mid-section portion 15, in order to accommodate different-sized mowers, and to also accommodate primary blades of different sizes and dimensions.

FIG. 2 depicts a bottom of view of auxiliary mower blade 1. In this view, mid-section portion 15, with center bolt aperture 8 is shown between corresponding secondary plane end portions 9, with angled wing portions 4 therebetween. Cutting region 3 is shown at the front edge of right end portion 9 and at the rear edge of left end portion 9. Cutting region 3 includes cutting edge 7 that is provided on the cutting surface of auxiliary mower blade 1. Cutting edge 7 of cutting region 3 originates from the top forward surface of the front edge of right end portion 9 and is angled down towards the back and bottom surface of the front edge of right end portion 9. Similarly, in the embodiment shown in FIG. 2, another cutting edge 7 is provided on the rear back edge of left end portion 9. This left cutting edge 7 originates from the top rear surface of the back edge of left end portion 9 and is angled down towards the back and bottom surface of the rear edge of left end portion 9. Cutting edges 7 provide for a sharp, clean initial cut of the debris and a downward direction being imposed upon that cut clipping, unlike traditional cutting edges that are ground from the forward bottom surface of the blade angled to the back upper surface of the blade, which directs the cut debris upwards. Although the embodiment of FIG. 2 shown front right and left rear cutting edges 7, other combinations of cutting edges 7 are within the scope of the present disclosure. For example, a cutting edge 7 can be disposed on the front edge of the left end portion 9 and the rear edge of the right front end portion 9.

The downward direction of the expulsion of the clippings may be enhanced by adding elongated rib sections 2. Rib sections 2 are used for strength and airflow direction and create a camber similar to that found in an airplane wing in order to help creates airflow that propels the cut debris deep into the grass bed, as a very small mulched particle usually about ⅛ of an inch to ¼ of an inch in size. This smaller particle is left behind and is not picked back up by the mower. Each rib section 2 may extend along the bottom surface of the substantial length of a corresponding end portion 9. In some embodiments, rib sections 2 may also extend along the bottom surface of a portion of or all of a corresponding angled portion 4, as shown in FIG. 2.

FIG. 3 shows a perspective end view of blade 1. In this view, the downward-angled slope of cutting edge 7 of auxiliary mower blade 1 can be easily seen. In this embodiment, auxiliary mower blade 1 includes only one cutting edge 7 along the right end portion 9 (although not shown in FIG. 3, another cutting edge 7 can be disposed, for example, along the rear edge of left end portion 9). Also seen from this view is angle 10, which is created by the curved rib section 2. Angle 10 is with respect to the first longitudinal plane formed by mid-section 15 of auxiliary mower blade 1. Rib section 2 may be an elongated, and in some embodiments, curved rib extending to the substantial end of auxiliary mower blade 1. Rib section 2 in conjunction with cutting edges 7 are used to create a more gentle airflow. Auxiliary mower blade 1 used in this embodiment is effectively moving landscape material, while also cutting that landscape material. Auxiliary mower blade 1 is also moving air in the center area of the larger primary cutting blade. This provides an air flow pattern significantly different from that created by typical mower blade designs. While auxiliary mower blade 1 is feeding off the primary blade airflow, further cutting and reducing is carried out and the debris thrust down into the grass bed beneath the top layer of visible cut grass. This gives a finished appearance and helps to speed up decomposition to return nutrients back into topsoil.

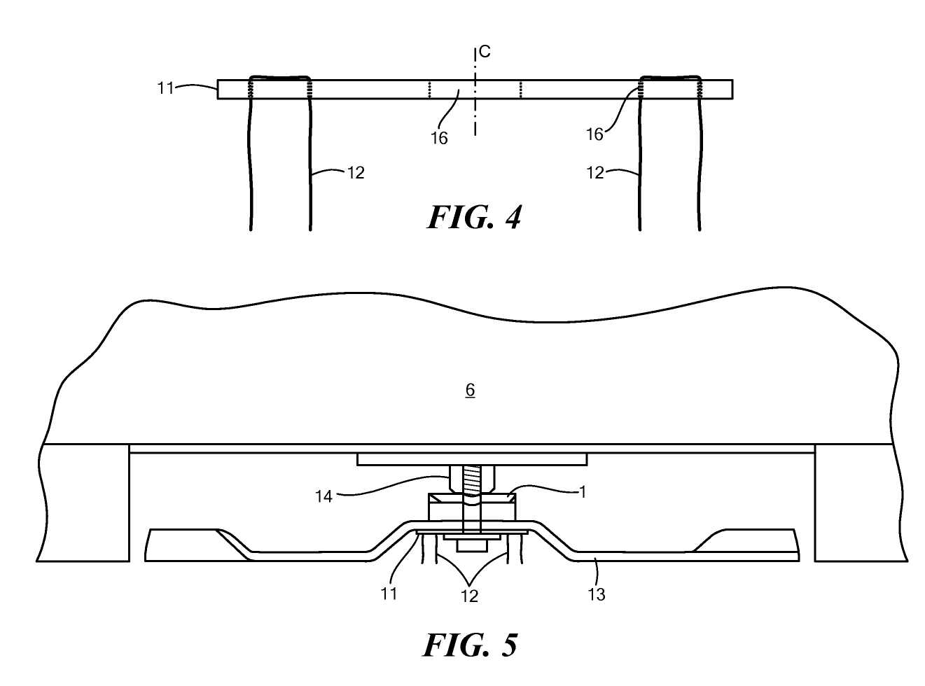

FIG. 4 shows an agitator plate 11 that can be used with auxiliary mower blade 1. Agitator plate 11 may have a one or more holes 16 that allow a user to thread a length of line 12, such as a replaceable nylon or heavy polymer line in an inverted u-shape by using two holes that are adjacent to each other. The length of the ends of line 12 is cut just short of the bottom surface of auxiliary mower blade 1. This keeps line 12 from fraying the top cut portions of the grass, which would be unsightly. Multiple positions are created this way. Agitator plate 11 is installed below mid-section portion 15 of auxiliary mower blade 1 and is used to keep the cut clippings from collecting in the dead zone of auxiliary mower blade 1. The ends of line 12 brush across the surface of the cut turf and re-energize the clippings to keep them moving within the mower deck.

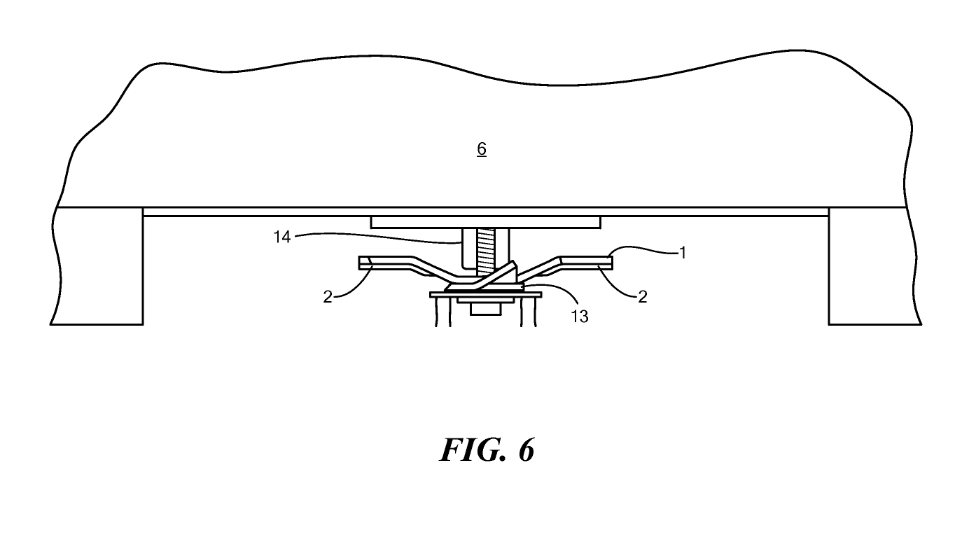

FIG. 5 illustrates a side view of a lawnmower deck 6 incorporating the auxiliary mower blade 1 of the present disclosure. As can be seen in FIG. 5, a primary mower blade 13 is supported by a mounting member 14. Affixed to mounting member 14 is auxiliary mower blade 1, which receives a mounting member 14 such as a bolt, or spindle, or other type of connection mechanism through aperture 8 (not shown in FIG. 5) therethrough. In one embodiment, auxiliary mower blade 1 is disposed at a substantially 90 degree angle with respect to primary blade 13. In other embodiments, the offset angle between auxiliary mower blade 1 and primary blade 13 can be less than 90 degrees. In one embodiment, auxiliary mower blade 1 includes rib section 2 (shown in FIG. 6) and is offset with respect to primary blade 13 by approximately 90 degrees. In another embodiment, auxiliary mower blade 1 does not include rib section 2 and is offset from primary blade 13 by between 10 and 15 degrees. The bolt received through aperture 8 can also extend through a corresponding aperture in primary blade 13. In one embodiment, agitator plate 11 abuts one side of primary blade 13.

Primary blade 13 and auxiliary mower blade 1 collectively form a lawnmower blade apparatus that is attachable to mounting member 14 of a lawnmower. As discussed above, primary cutting blade 13 is affixed to mounting member 14 of the lawnmower in a first orientation and an auxiliary mower blade 1 is affixed to mounting member 14 in a second orientation, where in their respective orientations, auxiliary mower blade 1 can be offset from primary cutting blade 13 by a range of angles. Further, in one embodiment, auxiliary mower blade 1 is shorter than primary cutting blade 13.

FIG. 6 provides a side view of lawnmower deck 6, rotated 90 degrees from the view of FIG. 5. FIG. 6 includes mower deck 6, spindle 14 through which a bolt or other type of connection mechanism extends. The bolt extends through an aperture within primary blade 13 and auxiliary blade 1. Ribs 2 of auxiliary mower blade 1 can be seen in this configuration.

FIG. 7 illustrates a bottom view of a commercial lawn mower with mower deck 6, and multiple auxiliary mower blade 1/primary blade 13 configurations. Mulch cover 5 is disposed on one end of deck 6. As shown in FIG. 7, auxiliary mower blade 1 is disposed at substantially 90 degrees with respect to primary blade 13, however, this angle is merely exemplary and can vary.

FIG. 8 illustrates a bottom view of an alternate lawn mower with mower deck 6, mulch cover 5 and a single auxiliary mower blade 1/primary blade 13 configuration. During operation of either the embodiment shown in FIG. 7 or the embodiment shown in FIG. 8, primary blade 13 works in harmony with auxiliary mower blade 1. Specifically, primary cutting blade 13 does the initial cutting and lifting of the grass and cuts the debris as it is projected to the top of mower deck 6 as it travels towards the center of the mowers blade areas. As the material works its way toward the center bottom portion of the area of primary blade 13, auxiliary mower blade 1 makes additional contact and begins cutting the debris into small, finer clippings, propelling them deep into the turf. As described above, auxiliary mower blade 1 may include one or more cutting edges 7 and/or rib section 2 to further enhance and improve the cutting of the debris and further direct the debris downward into the turf.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An auxiliary mower cutting blade attachable to a mounting member of a lawnmower, the auxiliary mower cutting blade comprising:
a mid-section portion forming a first longitudinal plane;
a first wing portion extending in a substantially upward-angled direction from a first side of the mid-section portion and a second wing portion extending in a substantially upward-angled direction from a second side of the mid-section portion; and
a first end portion extending from the first wing portion and a second end portion extending from the second wing portion, the first and second end portions forming a second longitudinal plane, the second longitudinal plane being above the first longitudinal plane.

2. The auxiliary mower cutting blade of claim 1, further comprising:
at least one of a first and a second rib, the first rib extending along a substantial length of a bottom surface of the first end portion and the second rib extending along a substantial length of a bottom surface of the second end portion.

3. The auxiliary mower cutting blade of claim 2, wherein the first rib further extends along at least a portion of a bottom surface of the first wing portion and the second rib further extends along at least a portion of a bottom surface of the second wing portion.

4. The auxiliary mower cutting blade of claim 2, wherein at least one of the first and the second rib is curved.

5. The auxiliary mower cutting blade of claim 1, wherein at least one of the first end portion and the second end portion further comprise a cutting region.

6. The auxiliary mower cutting blade of claim 5, wherein each of the first end portion and the second end portion includes a front edge and a back edge, and wherein the front edge of the first end portion includes the cutting region and the back edge of the second end portion includes the cutting region.

7. The auxiliary mower cutting blade of claim 6, wherein the cutting region comprises a downward-sloping cutting edge.

8. The auxiliary mower cutting blade of claim 7, where the downward-sloping cutting edge has a downward angle of substantially 30 degrees.

9. The auxiliary mower cutting blade of claim 1, wherein the mid-section portion includes an aperture configured to receive the mounting member.

10. An auxiliary mower cutting blade comprising:
a mid-section portion forming a first longitudinal plane;
a first wing portion extending in a substantially upward-angled direction from a first side of the mid-section portion and a second wing portion extending in a substantially upward-angled direction from a second side of the mid-section portion;
a first end portion extending from the first wing portion and a second end portion extending from the second wing portion, the first and second end portions forming a second longitudinal plane, the second longitudinal plane being above the first longitudinal plane; and
a cutting region disposed on an edge of at least one of the first end portion and the second end, the cutting region comprises a downward-sloping cutting edge.

11. A lawnmower blade apparatus attachable to a mounting member of a lawnmower, the apparatus comprising:
a primary cutting blade affixed to the mounting member in a first orientation; and
an auxiliary cutting blade affixed to the mounting member in a second orientation, the auxiliary cutting blade comprising:
a mid-section portion forming a first longitudinal plane;
a first wing portion extending in a substantially upward-angled direction from a first side of the mid-section portion and a second wing portion extending in a substantially upward-angled direction from a second side of the mid-section portion; and
a first end portion extending from the first wing portion and a second end portion extending from the second wing portion, the first and second end portions forming a second longitudinal plane, the second longitudinal plane being above the first longitudinal plane.

12. The apparatus of claim 11, wherein when the primary cutting blade is in the first orientation and the auxiliary cutting blade is in the second orientation, the auxiliary cutting blade is offset from the primary cutting blade by substantially 90 degrees.

13. The apparatus of claim 11, the auxiliary cutting blade further comprising:
at least one of a first and a second rib, the first rib extending along a substantial length of a bottom surface of the first end portion and the second rib extending along a substantial length of a bottom surface of the second end portion.

14. The apparatus of claim 13, wherein the first rib further extends along at least a portion of a bottom surface of the first wing portion and the second rib further extends along at least a portion of a bottom surface of the second wing portion.

15. The apparatus of claim 13, wherein at least one of the first and the second rib is curved.

16. The apparatus of claim 11, wherein at least one of the first end portion and the second end portion further comprise a cutting region.

17. The apparatus of claim 16, wherein each of the first end portion and the second end portion includes a front edge and a back edge, and wherein the front edge of the first end portion includes the cutting region and the back edge of the second portion includes the cutting region.

18. The apparatus of claim 17, wherein the cutting region comprises a downward-sloping cutting edge.

19. The apparatus of claim 18, where the downward-sloping cutting edge has a downward angle of substantially 30 degrees.

20. The apparatus of claim 11, wherein the auxiliary blade is shorter in length than the primary blade.
